(19) United States
(12) Patent Application Publication
(10) Pub. No.: US 2006/0201530 A1
(43) Pub. Date: Sep. 14, 2006

(54) Noose floss

(76) Inventor: King David Monroe, Petersburg, VA (US)

Correspondence Address: King David Monroe, P.O. Box 4030, Petersburg, VA, 23803, US

(21) Appl. No.: 10/989,183

(22) Filed: Mar. 11, 2005

(51) Int. Cl. A61C 15/00

(52) U.S. Cl. 132/321

(57) ABSTRACT

My Noose Floss is an improvement of what is used today, ‘dental floss.’ The thing that sets my Noose Floss apart from others' floss is the eye on each end of the flossing cord. Being able to form a noose (slipknot) at both ends of the flossing cord is the newest thing in dental floss. My Noose Floss provides a sure grip on the floss.

### CROSS REFERENCE TO RELATED APPLICATION

Not Applicable

### STATEMENT REGARDING FEDERALLY SPONSORED RESEARCH OR DEVELOPMENT

There is no federally sponsored research or development involved with this invention.

### SPECIFICATION OF NOOSE FLOSS

Application Ser. No. 10/989,183; Filing Date Nov. 16, 2004; King D. Monroe, Inventor. There is no knowledge of any floss with a fixed eye on each end of the cord. My Noose Floss is a thin thread or fiber used to clean between teeth. My floss comes in different lengths so that the user can comfortable clean between front, side, and back teeth. My floss has an eye (loop) on each end that is stationary. The cord of the floss is threaded through the stationary eye (loop) to form a noose (slipknot) that goes around the fingers.

### BACKGROUND OF THE INVENTION

My Noose Floss is an improvement of what is used today, dental floss, that is used to clean between teeth. Unlike the dental floss, my Noose Floss fits securely around the finger. By allowing the floss to form a noose on each end of the flossing strand, the floss is secured and won't slip off the fingers.

### BRIEF SUMMARY OF THE INVENTION

My Noose Floss, unlike dental floss, is precut to three different lengths and should be packaged with at least three yards of strands in a pack. Each Noose Floss strand has an eye at each end. The advantage and purpose of my Noose Floss is the grip you get on the floss.

### BRIEF DESCRIPTION OF THE SEVERAL VIEWS OF THE DRAWING

FIG. 1. Noose Floss strand

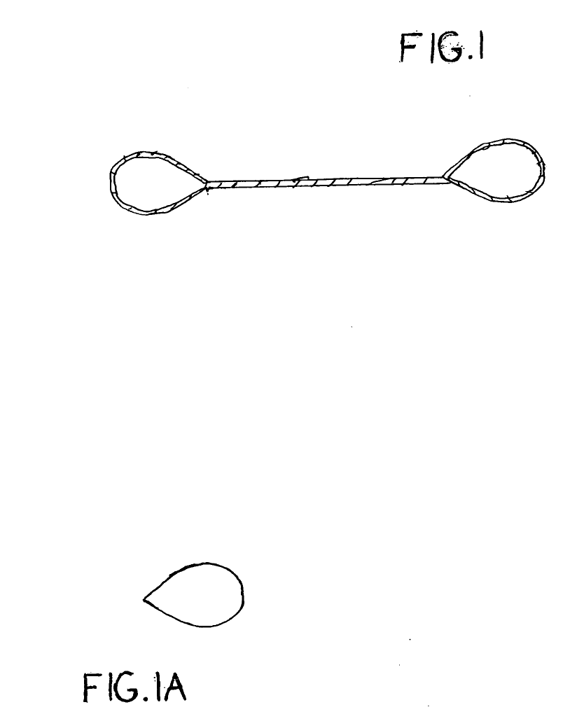

FIG. 1A. The eye of the Noose Floss

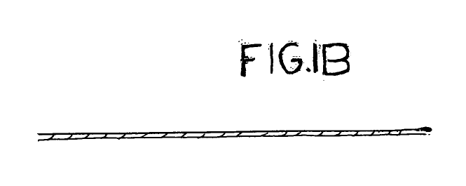

FIG. 1B. Cord

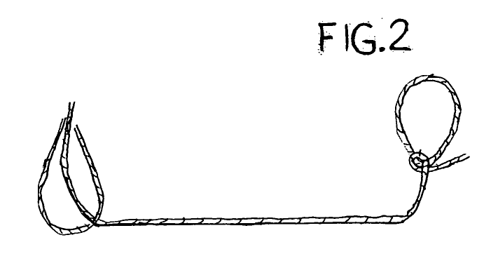

### DETAILED DESCRIPTION OF THE INVENTION

FIG. 2. The eyes of the Noose Floss are formed in three parts; the ends are knotted to form the flossing strand.

The machine and manufacture process for assembly would be a loom (used in rug and sweater making) so that more than one Noose Floss strand can be made at a time.

In this utility patent, I, King D. Monroe, am claiming:

1. floss with a stationary eye on each end. When the cord is threaded through the loop, it forms a noose that fits around the finger. This gives the user a grip on the floss when cleaning between the teeth.
